(19) United States
(12) Patent Application Publication
(10) Pub. No.: US 2013/0142441 A1
(43) Pub. Date: Jun. 6, 2013

(54) INFORMATION PROCESSING APPARATUS AND METHOD

(71) Applicant: Samsung Electronics Co., Ltd., Gyeonggi-do (KR)

(72) Inventor: Shuichi GOTO, Kanagawa (JP)

(73) Assignee: Samsung Electronics Co., Ltd., Gyeonggi-do (KR)

(21) Appl. No.: 13/687,564

(22) Filed: Nov. 28, 2012

(30) Foreign Application Priority Data
Dec. 2, 2011 (JP) 2011-264554
Oct. 12, 2012 (KR) 10-2012-0113479

(51) Int. Cl. G06T 5/00

(52) U.S. Cl. CPC G06T 5/002
USPC 382/218

(57) ABSTRACT

An information processing apparatus and method by which impulse noise can be canceled while surely maintaining details of a captured image is provided. The information processing apparatus includes an image acquisition unit for acquiring a captured image; a noise pixel extractor for extracting, from the captured image, a noise pixel that forms impulse noise; a pattern determiner for determining whether an arrangement of the noise pixel is identical to a predetermined pattern; and a noise canceller for performing noise cancellation with respect to the noise pixel upon a determination that the arrangement of the noise pixel is not identical to the predetermined pattern.

### PRIORITY

This application claims priority under 35 U.S.C. §119(a) to a Japanese Patent Application filed in the JPTO on Dec. 2, 2011 and assigned Serial No. JP 2011-264554 and a Korean Patent Application filed in the Korean Intellectual Property Office on Oct. 12, 2012 and assigned Serial No. KR 10-2012-0113479, the entire content of each of which are incorporated herein by reference.

### BACKGROUND OF THE INVENTION

1. Field of the Invention

The present invention relates generally to an information processing apparatus and method, and more particularly, to an information processing apparatus and method for cancelling impulse noise while maintaining details of a captured image.

2. Description of the Related Art

A conventional imaging device including an imaging element such as a Charge Coupled Device (CCD) is capable of adjusting the sensitivity of the imaging element. Such an imaging device performs imaging by increasing the sensitivity of the imaging element, even in a low-light environment such as during nighttime, such that the imaging device can generate a captured image in which color information (e.g., luminance, color, chrominance, etc.) of a subject is realized with high precision (i.e., a high-sensitivity image is generated). However, due to the high sensitivity of the imaging element, noise in the captured image increases, resulting in a noise problem. In particular, impulse noise, which has large amplitude and is irregularly generated, is problematic.

According to one method to address the noise problem, a median filter may be used for a captured image. The media filter replaces a pixel value of a target pixel with an intermediate value of pixel values in a target area including the target pixel. However, since the media filter uniformly replaces a pixel value of a target pixel with an intermediate value, regardless of whether the target pixel is a noise pixel including impulse noise, details of the captured image are damaged in this method. Therefore, this method cannot fundamentally solve the noise problem.

According to another method to address the noise problem, if a pixel value of a target pixel is a largest (or smallest) value in a target area including the target pixel, the pixel value of the target pixel may be replaced with the second largest pixel value (or the second smallest pixel value) in the target area. However, in this method, if the pixel value of the target pixel is largest in the target area, the pixel value of the target pixel is uniformly adjusted, regardless of whether the target pixel is a noise pixel, such that details of the captured image are damaged. As a result, this method cannot fundamentally solve the noise problem.

Japanese Patent Publication Gazette No. 2011-29704 refers to a technique for addressing the noise problem, which includes sorting a pixel value of a pixel included in a target area and determining whether a target pixel is a noise pixel or not based on a sort order of the target pixel.

However, if a linear image (e.g., an electric wire image, etc.) is included in a target area, this technique may incorrectly determine that the linear image is impulse noise. In this case, the linear image is removed from the captured image, such that details of the captured image may be damaged. Therefore, this technique cannot fundamentally solve the noise problem.

### SUMMARY OF THE INVENTION

Accordingly, the present invention has been made to address the above-stated problems and provide at least the advantages described below. An aspect of the present invention provides an information processing apparatus and method in which details of a captured image are surely maintained and impulse noise can be cancelled.

According to an aspect of the present invention, an information processing apparatus is provided. The information processing apparatus includes an image acquisition unit for acquiring a captured image; a noise pixel extractor for extracting a plurality of noise pixels that forms impulse noise with respect to other surrounding pixels within the captured image; a pattern determiner for determining whether an arrangement of the noise pixels is identical to a predetermined pattern; and a noise canceller for performing, upon a determination that the arrangement of the noise pixel is not identical to the predetermined pattern, noise cancellation with respect to the noise pixels.

According to another aspect of the present invention, an information processing method is provided. The method includes acquiring a captured image; extracting, from the captured image, a plurality of noise pixels that forms impulse noise with respect to other surrounding pixels within the captured image; determining whether an arrangement of the noise pixels is identical to a predetermined pattern; and performing, upon a determination that the arrangement of the noise pixels is not identical to the predetermined pattern, noise cancellation with respect to the noise pixels.

### BRIEF DESCRIPTION OF THE DRAWINGS

The above and other features and advantages of exemplary embodiments of the present invention will be more apparent from the following detailed description taken in conjunction with the accompanying drawings, in which:

FIG. 1 is a block diagram illustrating an information processing apparatus according to an embodiment of the present invention;

FIG. 2 is a diagram illustrating an example of a target area according to an embodiment of the present invention;

FIGS. 3A through 3C are diagrams for describing other examples of a target area according to an embodiment of the present invention;

FIG. 4 is a diagram illustrating sorting of a reference pixel according to an embodiment of the present invention;

FIG. 5 is a diagram illustrating contents of noise pixel extraction according to an embodiment of the present invention;

FIGS. 6A through 6D are diagrams illustrating examples of predetermined patterns according to an embodiment of the present invention;

FIG. 7 is a diagram illustrating contents of noise cancellation according to an embodiment of the present invention;

FIG. 8A is a diagram illustrating an example of an image from which impulse noise is canceled by conventional noise cancellation;

FIG. 8B is a diagram illustrating an example of an image from which impulse noise is canceled by noise cancellation according to an embodiment of the present invention; and

FIG. 9 is a flowchart illustrating a sequence of processing by an information processing apparatus according to an embodiment of the present invention.

### DETAILED DESCRIPTION OF EMBODIMENTS OF THE PRESENT INVENTION

Hereinafter, embodiments of the present invention are described in detail with reference to the accompanying drawings. In the following description, specific details such as detailed configuration and components are merely provided to assist in the overall understanding of the embodiments of the present invention. Therefore, it should be apparent to those of ordinary skill in the art that various changes and modifications of the embodiments described herein can be made without departing from the scope and spirit of the invention. In addition, descriptions of well-known functions and constructions are omitted for clarity and conciseness.

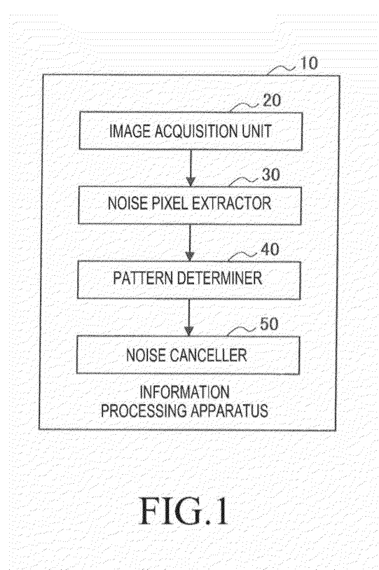

FIG. 1 is a block diagram illustrating an information processing apparatus according to an embodiment of the present invention.

Referring to FIG. 1, an information processing apparatus 10 includes an image acquisition unit 20, a noise pixel extractor 30, a pattern determiner 40, and a noise canceller 50. The image processing apparatus 10 has hardware such as a Central Processing Unit (CPU), a Read Only Memory (ROM), a Random Access Memory (RAM), various storage media (e.g., flash memories), etc., and the CPU reads and executes a program stored in the ROM, such that processing by each functional block is executed. More specifically, the ROM stores the program for executing the functional block in the image processing apparatus 10. The image processing apparatus 10 may be embedded in an imaging device or may be a separate configuration from an imaging device.

The image acquisition unit 20 acquires a captured image and outputs the image to the noise pixel extractor 30 and the noise canceller 50. The captured image includes a plurality of pixels, each of which has a pixel value (e.g., color, chrominance, luminance, etc.). The image acquisition unit 20 may acquire the captured image from an imaging element of the imaging device or from a storage medium if the information processing apparatus 10 is embedded in the imaging device. If the information processing apparatus 10 is configured separately from the imaging device, the image acquisition unit 20 may acquire the captured image from the imaging device connected to the information processing apparatus 10 in a wired or wireless manner.

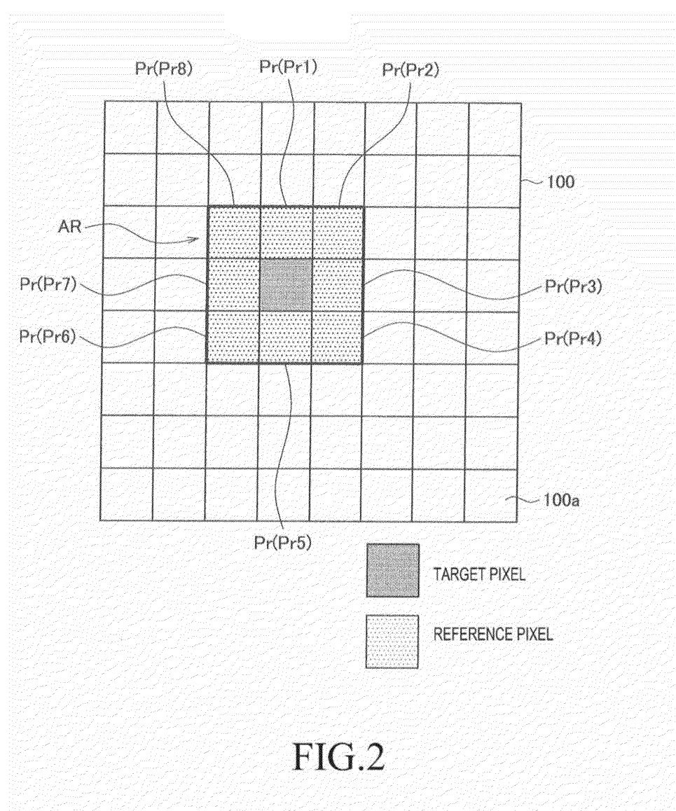

The noise pixel extractor 30 extracts, from the captured image, a target pixel Pc and reference pixels Pr (Pr1 through Pr8), which are adjacent to the target pixel Pc in up/down/left/right directions or in a diagonal direction. For example, the noise pixel extractor 30 extracts the target pixel Pc and the reference pixels Pr (Pr1 through Pr8) from a captured image 100 including a plurality of pixels 100a as shown in FIG. 2.

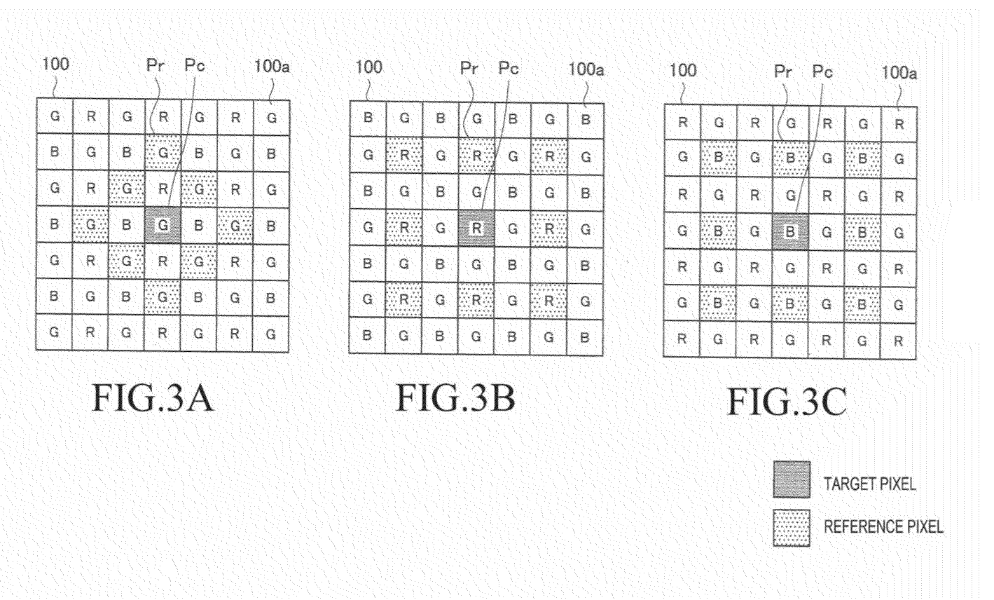

If pixels of the captured image are arranged in a Bayer pattern, the noise pixel extractor 30 extracts a pixel having the same color as the target pixel Pc as the reference pixel Pr. For example, as shown in FIG. 3A, the pixels 100a of the captured image 100 are arranged in a Bayer pattern, and if the target pixel Pc is a green pixel G, the noise pixel extractor 30 extracts green pixels G, which are adjacent to the target pixel Pc, in the up/down/left/right directions or in the diagonal direction, as reference pixels Pr. In FIGS. 3A through 3C, ‘R’, ‘G’, and ‘B’ added to the pixels 100a indicate colors of the respective pixels 100a. More specifically, ‘R’ indicates red, ‘G’ indicates green, and ‘B’ indicates blue. Likewise, as shown in FIG. 3B, if the target pixel Pc is a read pixel R, the noise pixel extractor 30 extracts red pixels R, which are adjacent to the target pixel Pc, in the up/down/left/right directions or in the diagonal direction, as reference pixels Pr. Similarly, as shown in FIG. 3C, if the target pixel Pc is a blue pixel B, the noise pixel extractor 30 extracts blue pixels B, which are adjacent to the target pixel Pc, in the up/down/left/right directions or in the diagonal direction, as reference pixels Pr.

As described above, the noise pixel extractor 30 extracts pixels, which are adjacent to the target pixel Pc in the up/down/left/right directions or in the diagonal direction, as reference pixels Pr, but embodiments of the present invention are not limited to this particular manner of extracting the reference pixels Pr. For example, according to another embodiment of the present invention, the noise pixel extractor 30 may also extract pixels, which are adjacent to the target pixel Pc only in the up/down/left/right directions, as the reference pixels Pr.

The noise pixel extractor 30 may set an area including the target pixel Pc and reference pixels Pr as a target area AR and perform processing described in a manner further described herein below, such that the noise pixel extractor 30 extracts a noise pixel from the target area AR. More specifically, the noise pixel extractor 30 sorts the reference pixels Pr according to a pixel value and assigns a sort number (number indicating an arranged order) to each reference pixel Pr.

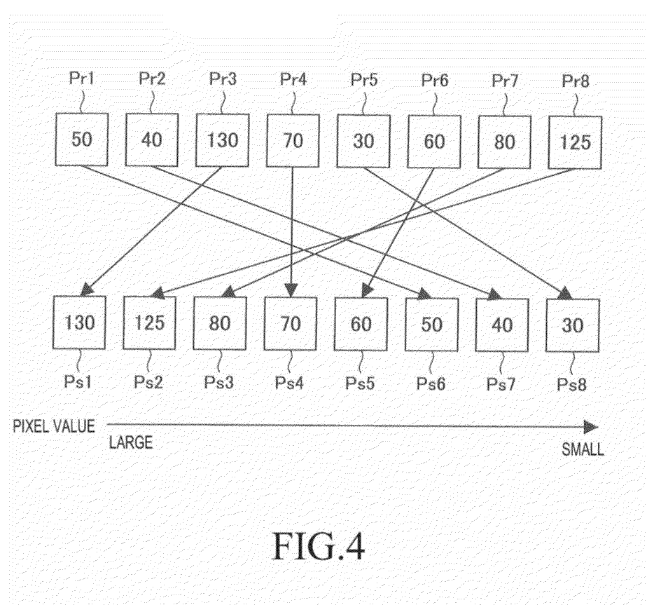

FIG. 4 is a diagram illustrating sorting of a reference pixel according to an embodiment of the present invention.

Referring to FIG. 4, if the reference pixels Pr1 through Pr8 have pixel values (indicated by numbers in boxes indicating respective pixels), the noise pixel extractor 30 sorts the reference pixels Pr1 through Pr8 in an order of reference pixels Pr3, Pr8, Pr7, Pr6, Pr1, Pr2, and Pr5. The noise pixel extractor 30 sequentially adds sort numbers Ps of 1 through 8 (Ps1 through Ps8) to the reference pixels starting from Pr3.

The noise pixel extractor 30 uses a positive direction as a reference direction, and determines whether the target pixel Pc and (k−1) reference pixels

Pr in the positive direction are noise pixels (hereinafter, this processing will be referred to as ‘positive-direction determination’). Herein, a positive direction, as the reference direction, refers to a direction in which a sort number increases from a reference pixel Pr having a minimal sort number (=1). k is an integer greater than 1 and less than N. N is the number of reference pixels Pr (e.g., 8 pixels). Thus, if k is greater than 2, (k−1) reference pixels Pr in the positive direction refer to reference pixels Pr having sort numbers 1−(k−1). For k=1, the noise pixel extractor 30 determines whether the target pixel Pc is a noise pixel.

More specifically, the noise pixel extractor 30 sets, as a reference value Nb, the smaller one of a pixel value Ps(k−1) of a (k−1)^{th} reference pixel Pr from a reference pixel Pr having the minimal sort number and a pixel value PcN of the target pixel Pc. The noise pixel extractor 30 sets Nb=PcN for k=1.

The noise pixel extractor 30 calculates a noise level based on the reference value Nb and a pixel value Psk of a k^{th} reference pixel Pr from the reference pixel Pr having the minimal sort number, according to the following Equation

NL=Nb−Psk (1)

The noise pixel extractor 30 determines that the target pixel Pc and the (k−1) reference pixels Pr in the positive direction are noise pixels, if the noise level is greater than or equal to a predetermined threshold TH_NL. If the noise level is less than the predetermined threshold TH_NL, the noise pixel extractor 30 determines that some or all of the target pixel Pc and the (k−1) reference pixels Pr in the positive direction are not noise pixels. The noise pixel extractor 30 determines whether all k reference pixels in the positive-direction are noise pixels.

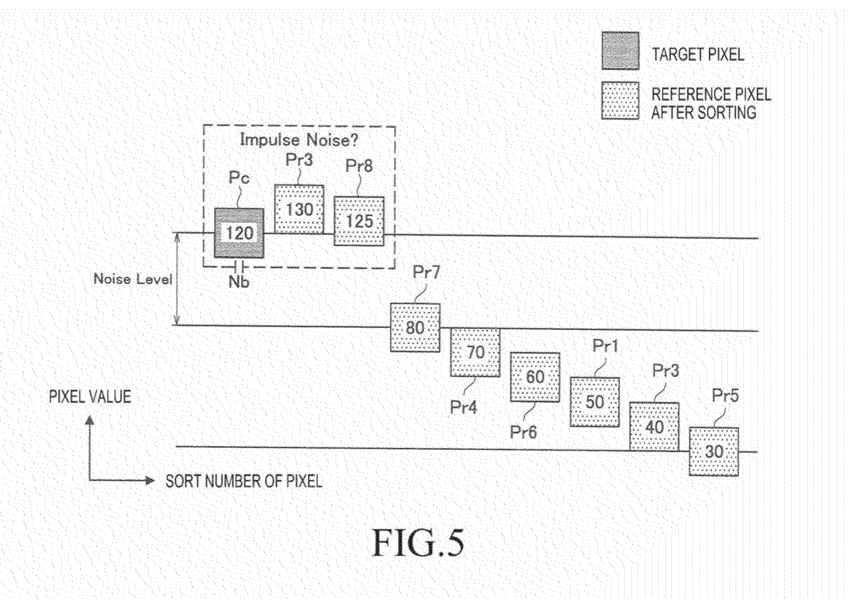

FIG. 5 is a diagram illustrating contents of noise pixel extraction according to an embodiment of the present invention.

Referring to FIG. 5, an xy plane is formed with an x axis indicating a sort number and a y axis indicating a pixel value, and on the xy plane, the target pixel Pc and the reference pixels Pr are arranged. In boxes of the target pixel Pc and the reference pixels Pr1 through Pr8, pixel values of the respective pixels are marked. The pixel values of the reference pixels Pr1 through Pr8 are equal to the values shown in FIGS. 4, and k=3. In this example, Nb=PcN=120, such that NL=40. Thus, the noise pixel extractor 30 determines that the target pixel Pc and two reference pixels Pr3 and Pr8 in the positive direction are noise pixels, if the threshold value TH_NL is less than 40.

The noise pixel extractor 30 uses a negative direction as a reference direction, and determines whether the target pixel Pc and (k−1) reference pixels Pr in the negative direction are noise pixels (hereinafter, this processing will be referred to as ‘negative direction determination’). Herein, a negative direction, as the reference direction, refers to a direction in which a sort number decreases from a reference pixel Pr having a maximal sort number (=8). If k is greater than 2, (k−1) reference pixels Pr in the negative direction refer to reference pixels Pr having sort numbers N−(N−k+2). For k=1, the noise pixel extractor 30 determines whether the target pixel Pc is a noise pixel.

More specifically, the noise pixel extractor 30 sets, as the reference value Nb, the larger one of a pixel value Ps(N−k+2) of a (N−k+2)^{th} reference pixel Pr from a reference pixel Pr having the maximal sort number and a pixel value PcN of the target pixel Pc. The noise pixel extractor 30 sets Nb=PcN for k=1.

The noise pixel extractor 30 calculates a noise level based on the reference value Nb, a pixel value Ps(N−k+1) of a (N−k+1)^{th} reference pixel Pr from the reference pixel Pr having the maximal sort number, and Equation 2 provided below.

NL=Ps(N−k+1)−Nb (2)

The noise pixel extractor 30 determines that the target pixel Pc and the (k−1) reference pixels Pr in the negative direction are noise pixels, if the noise level is greater than or equal to the predetermined threshold TH_NL. If the noise level is less than the predetermined threshold TH_NL, the noise pixel extractor 30 determines that some or all of the target pixel Pc and the (k−1) reference pixels Pr in the negative direction are not noise pixels. The noise pixel extractor 30 performs negative direction determination for all ks. The threshold TH_NL may be constant regardless of the reference direction and k, or may be set depending on the reference direction or k.

The noise pixel extractor 30 extracts a noise pixel from the target area AR by performing positive-direction determination and negative-direction 30 determination. The noise pixel extractor 30 generates noise determination result information that is associated with coordinates of the target pixel Pc, a result of positive-direction determination, and a result of negative-direction determination, and outputs the noise determination result information to the pattern determiner 40.

The pattern determiner 40 determines whether any one of pixels of the target area AR forms a noise pixel based on the noise determination result information. The pattern determiner 40 sets at least one predetermined pattern based on the number of noise pixels. Herein, the predetermined pattern refers to a pattern that passes through the target pixel Pc and linearly traverses the target area AR. The number of pixels of the predetermined pattern is equal to the number of noise pixels.

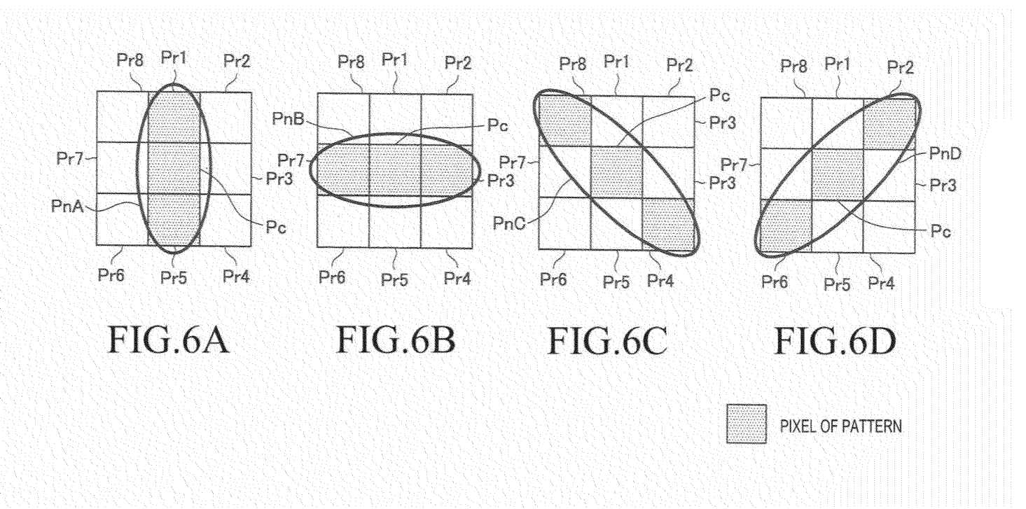

FIGS. 6A through 6D are diagrams illustrating examples of predetermined patterns according to an embodiment of the present invention In particular, FIGS. 6A through 6D show predetermined patterns PnA through PnD when the number of noise pixels is 3.

Referring to FIGS. 6A through 6D, the predetermined pattern PnA passes through the target pixel Pc and traverses the target area AR up and down. That is, the predetermined pattern PnA includes the target pixel Pc and the reference pixels Pr1 and Pr5.

The predetermined pattern PnB passes through the target pixel Pc and traverses the target area AR to the left and to the right. More specifically, the predetermined pattern PnA includes the target pixel Pc and the reference pixels Pr3 and Pr7.

The predetermined pattern PnB passes through the target pixel Pc and traverses the target area AR from the left top to the right bottom. More specifically, the predetermined pattern PnA includes the target pixel Pc and the reference pixels Pr4 and Pr8.

The predetermined pattern PnB passes through the target pixel Pc and traverses the target area AR from the right top to the left bottom. More specifically, the predetermined pattern PnA includes the target pixel Pc and the reference pixels Pr2 and Pr6.

The pattern determiner 40 compares an arrangement of noise pixels (or a noise pixel arrangement) with at least one predetermined pattern. More specifically, the pattern determiner 40 calculates a noise pixel cumulative value by adding pixel values of noise pixels. The pattern determiner 40 calculates a pattern pixel cumulative value by adding pixel values of pixels forming a predetermined pattern. The pattern determiner 40 determines that the noise pixel arrangement is identical to a predetermined pattern if the noise pixel cumulative value is equal to the pattern pixel cumulative value. If the noise pixel cumulative value is not equal to the pattern pixel cumulative value, the pattern determiner 40 determines that the noise pixel arrangement is not identical to the predetermined pattern. For example, the pattern determiner 40 calculates the pattern pixel cumulative value by adding the target pixel Pc and pixel values of the reference pixels Pr1 and Pr5, thus comparing the pattern pixel cumulative value with the noise pixel cumulative value to compare the noise pixel arrangement with the predetermined pattern PnA.

Accordingly, the pattern determiner 40 determines that the noise pixel arrangement is identical to the predetermined pattern if the number of noise pixels and a total sum of pixel values are equal to the number of pixels of a predetermined pattern and a total sum of pixel values.

The pattern determiner 40 determines that the target pixel Pc is a target of noise cancellation, if the noise pixel arrangement is identical to none of one predetermined pattern or plural predetermined patterns. The pattern determiner 40 associates target pixel information indicating coordinates of the target pixel Pc with noise cancellation requesting information for requesting noise cancellation and outputs them to the noise canceller 50. The pattern determiner 40 associates target pixel information indicating coordinates of the target pixel Pc with noise cancellation non-requesting information in order to avoid requesting noise cancellation, and outputs the associated information to the noise canceller 50, if the arrangement of pixel values is identical to any one predetermined pattern.

If the noise pixel arrangement is identical to a predetermined pattern, the noise pixel is likely to form a linear image. In this case, if noise cancellation is performed with respect to the noise pixel, the linear image may be lost (i.e., details of a captured image may be damaged). Thus, the pattern determiner 40 determines that the target pixel Pc is a target of noise cancellation, upon determining that the noise pixel arrangement is identical to none of one predetermined pattern or plural predetermined patterns.

The noise canceller 50 performs noise cancelation with respect to the target pixel Pc associated with the noise cancellation requesting information among target pixels Pc of the captured image (i.e., the noise pixel). More specifically, the noise canceller 50 replaces a pixel value of the target pixel Pc with a value closest to a pixel value of the target pixel Pc (hereinafter, referred to as a ‘closest value’) among pixel values of normal pixels (pixel except for noise pixels) in the target area AR.

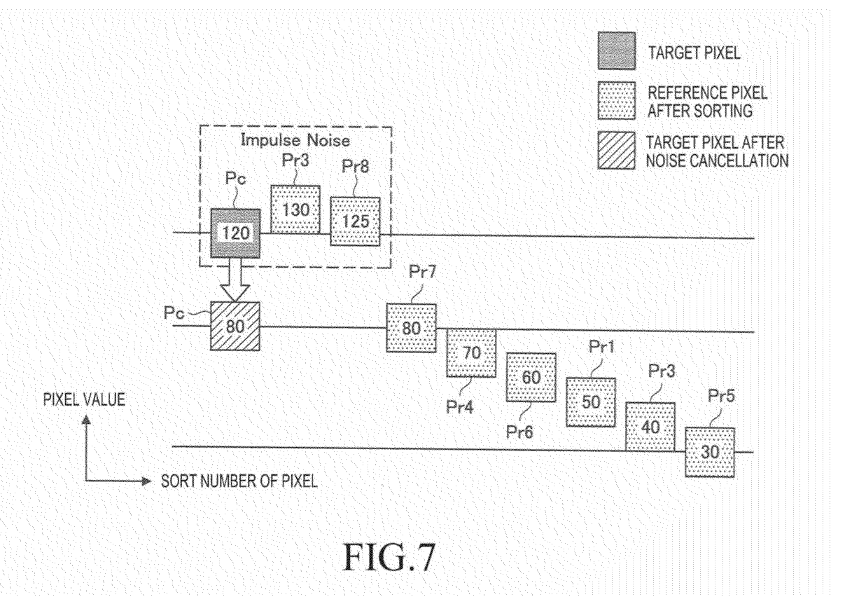

FIG. 7 is a diagram illustrating contents of noise cancellation according to an embodiment of the present invention.

Referring to FIGS. 5 and 7, in the present example, the target pixel Pc and the reference pixels Pr3 and Pr8 shown in FIG. 5 are noise pixels and the target pixel Pc is a target of noise cancellation. Among normal pixels, a pixel value of the reference pixel Pr7 is closest to a pixel value of the target pixel Pc. Thus, in this example, the noise canceller 50 replaces the pixel value of the target pixel Pc with the pixel value ‘80’ of the reference pixel Pr7. Thus, the noise canceller 50 cancels impulse noise from the target pixel Pc. The noise canceller 50 may also clip the pixel value of the target pixel Pc to a value in a predetermined range from the closest value. In this way, the noise canceller 50 performs noise cancellation together with intensity adjustment.

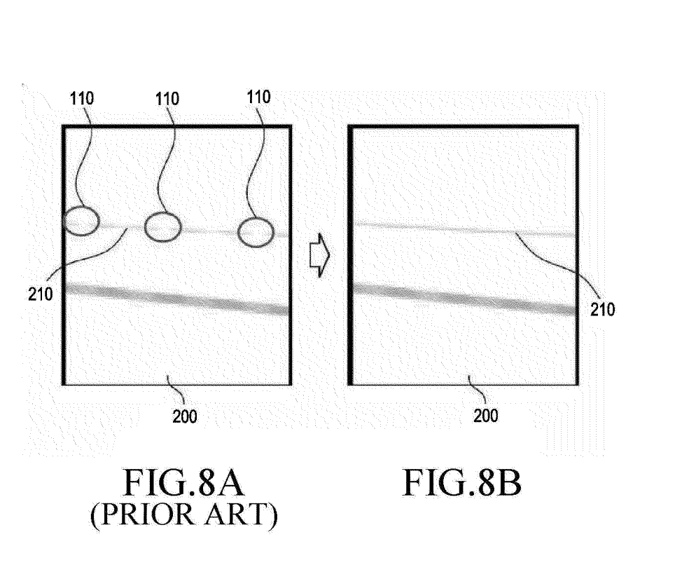

FIG. 8A is a diagram illustrating an example of an image from which impulse noise is canceled by conventional noise cancellation. FIG. 8B is a diagram illustrating an example of an image from which impulse noise is canceled by noise cancellation according to an embodiment of the present invention. More specifically, FIGS. 8A and 8B show comparative examples in which conventional noise cancellation and noise cancellation according to an embodiment of the present invention are applied to an actual captured image 200.

FIG. 8A is illustrates an example of the captured image 200 after conventional noise cancellation (i.e., noise cancellation described in Japanese Patent Publication Gazette No. 2011-29704 is applied thereto). Referring to FIG. 8A, a portion 110 of a linear image 210 is lost, because the technique of Japanese Patent Publication Gazette No. 2011-29704 may erroneously determine that the linear image is an impulse noise, as described herein above.

FIG. 8B illustrates an example of the captured image 200 after noise cancellation according to an embodiment of the present invention is applied thereto. Referring to FIG. 8B, if a noise pixel arrangement is not identical to a predetermined pattern, noise cancellation is performed on noise pixels, as described herein above.

Hereinafter, a sequence of processing by an information processing apparatus according to an embodiment of the present invention is described.

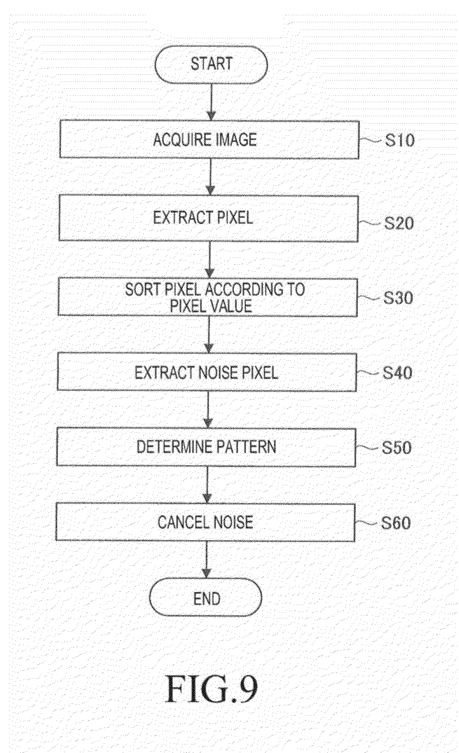

FIG. 9 is a flowchart illustrating a sequence of processing by an information processing apparatus according to an embodiment of the present invention.

Referring to FIG. 9, in step S10, the image acquisition unit 20 of the processing apparatus 10 acquires a captured image and outputs the captured image to the noise pixel extractor 30 and the noise canceller 50.

In step S20, the noise pixel extractor 30 extracts, from the captured image, the target pixel Pc and the reference pixels Pr (Pr1 through Pr8), which are adjacent to the target pixel Pc in up/down/left/right directions or in a diagonal direction.

In step S30, the noise pixel extractor 30 sets an area including the target pixel Pc and the reference pixels Pr as the target area AR. The noise pixel extractor 30 then sorts the reference pixels Pr according to a pixel value and assigns a sort number to each reference pixel Pr.

In step S40, the noise pixel extractor 30 performs positive-direction determination and negative-direction determination for all ks to extract noise pixels from the target area AR. The noise pixel extractor 30 generates noise determination result information associated with coordinates of the target pixel Pc, results of a positive-direction determination, and results of a negative-direction determination, and outputs the noise determination result information to the pattern determiner 40.

In step S50, the pattern determiner 40 determines, based on the noise determination result information, whether any one of pixels of the target area AR forms a noise pixel. The pattern determiner 40 then sets at least one predetermined pattern based on the number of noise pixels.

The pattern determiner 40 compares a noise pixel arrangement with the at least one predetermined pattern. More specifically, the pattern determiner 40 calculates a noise pixel cumulative value by adding pixel values of the noise pixels. The pattern determiner 40 also calculates a pattern pixel cumulative value by adding pixel values of pixels forming a predetermined pattern. The pattern determiner 40 determines that the noise pixel arrangement is identical to a predetermined pattern if the noise pixel cumulative value is equal to the pattern pixel cumulative value. Unless the noise pixel cumulative value is equal to the pattern pixel cumulative value, the pattern determiner 40 determines that the noise pixel arrangement is not identical to the predetermined pattern.

The pattern determiner 40 determines that the target pixel Pc is a target of noise cancellation, if the noise pixel arrangement is not identical to any of the at least one predetermined pattern. The pattern determiner 40 associates target pixel information indicating coordinates of the target pixel Pc with noise cancelation requesting information for requesting noise cancellation and outputs them to the noise canceller 50. If the noise pixel arrangement is identical to a predetermined pattern, the pattern determiner 40 associates the target pixel information indicating the coordinates of the target pixel Pc with noise cancelation non-requesting information to avoid requesting noise cancellation and outputs them to the noise canceller 50.

In step S60, the noise canceller 50 performs noise cancellation with respect to the target pixel Pc associated with the noise cancellation requesting information among target pixels Pc of the captured image (i.e., the noise pixel).

More specifically, the noise canceller 50 replaces a pixel value of the target pixel Pc with a closest value among pixel values of normal pixels in the target area AR. Thereafter, the information processing apparatus 10 terminates processing.

In this manner, according to an embodiment of the present invention, the information processing apparatus 10 performs noise cancellation with respect to a noise pixel if a noise pixel arrangement is not identical to a predetermined pattern, thereby reducing the possibility of performing noise cancellation is performed with respect to a linear image. Accordingly, the information processing apparatus 10 cancels impulse noise while maintaining details of a captured image.

Herein, the noise pixel extractor 30 may extract any one pixel from a captured image as a target pixel and may extract a noise pixel from a target area including the target pixel. Thus, the information processing apparatus 10 extracts any one pixel forming the captured image as the target pixel Pc and extracts the noise pixel from the target area AR including the target pixel Pc, thereby certainly extracting the noise pixel. The information processing apparatus 10 sets at least one predetermined pattern based on the number of noise pixels, and compares a noise pixel arrangement with each of the at least one predetermined pattern. The information processing apparatus 10 performs noise cancellation with respect to the noise pixel upon determining that the noise pixel arrangement is not identical to any of the at least one predetermined pattern.

More specifically, the pattern determiner 40 of the information processing apparatus 10 sets at least one predetermined pattern based on the number of noise pixels and compares a noise pixel arrangement with the at least one predetermined pattern, and the noise canceller 50 performs noise cancellation on the noise pixel upon determining that the noise pixel arrangement is not identical to any of the at least one predetermined pattern. Therefore, the information processing apparatus 10 reduces the possibility of performing noise cancellation with respect to a linear image.

Herein, the pattern determiner 40 may set a pixel pattern that linearly traverses the target area AR as a predetermined pattern. Thus, the information processing apparatus 10 sets a pixel pattern that linearly traverses the target area AR, as a predetermined pattern, thus reducing the possibility of performing noise cancellation with respect to a linear image.

The pattern determiner 40 also determines that the noise pixel arrangement is identical to a predetermined pattern if the number of noise pixels and a sum of pixel values are equal to the number of pixels of the predetermined pattern and a sum of pixel values. In this way, the information processing apparatus 10 determines that the noise pixel arrangement is identical to a predetermined pattern if the number of noise pixels and a sum of pixel values are equal to the number of pixels of the predetermined pattern and a sum of pixel values, thereby reducing the possibility of performing noise cancellation with respect to a linear image.

As described above, according to embodiments of the present invention, impulse noise is canceled while maintaining details of a captured image.

While the present invention has been described with reference to the foregoing embodiments and the accompanying drawings, the present invention is not limited thereto. It is obvious that those of ordinary skill in the art can reach various changes or modifications within the technical spirit defined in the claims and such changes or modifications are understood as being included in the spirit and scope of the present invention, as defined by the appended claims and their equivalents.

What is claimed is:

1. An information processing apparatus comprising:
an image acquisition unit for acquiring a captured image;
a noise pixel extractor for extracting a plurality of noise pixels that forms impulse noise with respect to other surrounding pixels within the captured image;
a pattern determiner for determining whether an arrangement of the noise pixels is identical to a predetermined pattern; and
a noise canceller for performing, upon a determination that the arrangement of the noise pixel is not identical to the predetermined pattern, noise cancellation with respect to the noise pixels.

2. The information processing apparatus of claim 1, wherein the noise pixel extractor extracts, as a target pixel, a pixel from the captured image and extracts the noise pixels from a target area including the target pixel.

3. The information processing apparatus of claim 2, wherein the pattern determiner sets at least one predetermined pattern according to a number of noise pixels in the captured image and compares the arrangement of the noise pixels with the at least one predetermined pattern.

4. The information processing apparatus of claim 3, wherein, if the pattern determiner determines that the arrangement of the noise pixels is not identical to any of the at least one predetermined pattern, the noise canceller performs noise cancellation with respect to the noise pixels.

5. The information processing apparatus of claim 3, wherein the pattern determiner sets, as the predetermined pattern, a pattern of pixels that linearly traverses the target area.

6. The information processing apparatus of claim 3, wherein the pattern determiner determines that the arrangement of the noise pixels is identical to the predetermined pattern, if the number of noise pixels and a sum of pixel values of the target area are equal to the number of pixels of the predetermined pattern and a sum of pixel values of the predetermined pattern.

7. An information processing method comprising:
acquiring a captured image;
extracting, from the captured image, a plurality of noise pixels that forms impulse noise with respect to other surrounding pixels within the captured image;
determining whether an arrangement of the noise pixels is identical to a predetermined pattern; and
performing, upon a determination that the arrangement of the noise pixels is not identical to the predetermined pattern, noise cancellation with respect to the noise pixels.

8. The information processing method of claim 7, wherein extracting the noise pixels comprises:
extracting, as a target pixel, a pixel from the captured image; and
extracting the noise pixels from a target area including the target pixel.

9. The information processing method of claim 8, wherein determining whether the pattern is identical to a predetermined pattern comprises:
setting at least one predetermined pattern according to a number of noise pixels in the captured image; and
comparing the arrangement of the noise pixels with the at least one predetermined pattern.

10. The information processing method of claim 9, wherein performing the noise cancellation comprises:
performing noise cancellation with respect to the noise pixels upon a determination that the arrangement of the noise pixels is not identical to any of the at least one predetermined pattern.

11. The information processing method of claim 9, wherein the predetermined pattern is set using a pattern of pixels that linearly traverses the target area.

12. The information processing method of claim 8, wherein the determining whether the arrangement of the noise pixels is identical to the predetermined pattern comprises determining that the arrangement of the noise pixels is identical to the predetermined pattern, if the number of noise pixels and a sum of pixel values of the target area are equal to the number of pixels of the predetermined pattern and a sum of pixel values of the predetermined pattern.
